(19) United States
(12) Patent Application Publication
(10) Pub. No.: US 2025/0289087 A1
(43) Pub. Date: Sep. 18, 2025

(54) MASS DAMPER ASSEMBLY FOR VERTICAL TURNING CENTER

(71) Applicant: FIVES GIDDINGS & LEWIS, LLC, Fond du Lac, WI (US)

(72) Inventor: David Umstadt, Markesan, WI (US)

(21) Appl. No.: 18/908,934

(22) Filed: Oct. 8, 2024

Related U.S. Application Data
(60) Provisional application No. 63/565,630, filed on Mar. 15, 2024.

(51) Int. Cl. B23Q 1/48

(52) U.S. Cl. CPC B23Q 1/48

(57) ABSTRACT

A vertical turning center for cutting workpieces including a rotating table assembly that is configured to releasably couple to a workpiece and spin the workpiece at a speed sufficient to cut the workpiece; a ram having a cutting tool at a distal end configured to engage an outer surface of the workpiece; and a mass damper assembly coupled to the rotating table assembly and supported by at least one elastomeric spacer.

### TECHNICAL FIELD

The present application relates to vertical turning machines and, more particularly, to a vertical turning center that is capable of spinning a workpiece at a speed sufficient to cut the workpiece.

### BACKGROUND

Vertical turning centers are used to cut workpieces. The vertical turning center spins a workpiece about a vertical axis to precisely cut the workpiece into a desired geometry. As the vertical turning center spins the workpiece, a ram moves a cutting tool to align the workpiece with the cutting tool. The cutting tool engages a surface of the workpiece to selectively remove material from the workpiece. Friction from the cutting tool engaging the workplace can cause unwanted vibration that may adversely affect the quality of a cut. It may be desirable to eliminate or reduce this unwanted vibration.

### SUMMARY

In one implementation, a vertical turning center for cutting workpieces includes a rotating table assembly that is configured to releasably couple to a workpiece and spin the workpiece at a speed sufficient to cut the workpiece; a ram having a cutting tool at a distal end configured to engage an outer surface of the workpiece; and a mass damper assembly coupled to the rotating table assembly and supported by at least one elastomeric spacer.

### BRIEF DESCRIPTION OF THE DRAWINGS

FIG. 1 is a perspective view depicting an implementation of a vertical turning center capable of using a mass damper assembly;

FIG. 2 is another perspective view depicting an implementation of a vertical turning center capable of using a mass damper assembly;

FIG. 3 is a perspective view depicting an implementation of a vertical turning center using a mass damper assembly;

FIG. 4 is a perspective view depicting an implementation of a mass damper assembly used with a vertical turning center;

FIG. 5 is a cross-sectional view depicting a portion of an implementation of a mass damper assembly used with a vertical turning center;

FIG. 6 is another cross-sectional view depicting an implementation of a mass damper assembly used with a vertical turning center;

FIG. 7 is another cross-sectional view depicting a portion of an implementation of a mass damper assembly used with a vertical turning center;

FIG. 8 is another cross-sectional view depicting a portion of an implementation of a mass damper assembly used with a vertical turning center;

FIG. 9 is a plan view depicting a portion of an implementation of a mass damper assembly used with a vertical turning center;

FIG. 10 is a perspective view depicting a portion of an implementation of a mass damper assembly used with a vertical turning center; and

FIG. 11 is a graph depicting test results relating to a mass damper assembly used with a vertical turning center.

### DETAILED DESCRIPTION

A vertical turning center (sometimes referred to as a vertical lathe or a vertical turning machine) can include a rotating table that releasably holds a workpiece and a cutting tool held by a ram in an XZ plane. The ram can move the cutting tool into engagement with the workpiece as the workpiece is spun by the rotating table. Radial and axial motion of the tool combined with the rotating work piece generate the desired workpiece geometry such as cylindrical, conical, toroidal, planar, threads, etc. The quality of the finished workpiece is directly related to the accuracy in which the tool is positioned relative to the workpiece.

As the rotating table assembly spins the workpiece and the cutting tool engages the workpiece, friction can create unwanted vibrations that may adversely affect the quality of a cut. Faster cutting speeds and feeds as well as deeper depths of tool engagement are desirable as this results in greater productivity but also result in higher cutting forces, structural deflection, and mechanical energy. The machine's capacity for resisting dynamic cutting energy is defined by the mass, stiffness, and damping of its components. Dynamic stiffness is a measure of how the structure deflects different amounts for a given force at different frequencies. Higher deflections occur for lower forces at resonant frequencies and define the cutting capacity of the machine tool. Motion from vibration of the tool or workpiece cause the cut to vary from the desired radius and create a surface that is out of round and/or rough. At high vibration levels machine damage can occur. Unhealthy high noise levels can occur. Friction at the cutting tool excites the machine resonance in the same way a violin bow excites the string. For example, at particular frequencies and/or angular velocities of the rotating table assembly, unwanted chatter can be created on an outer surface of the workpiece during the cutting process. In one test of a workpiece coupled with the rotating table assembly, chatter on the workpiece can exist at a frequency of 19 hertz (Hz). The existence of chatter can indicate that the mechanical system of the workpiece and the rotating table assembly may lack dynamic stiffness sufficient to maintain a chatter-free cutting surface on the workpiece. Given the extremely small tolerances desired when cutting workpieces using a vertical turning machine, it would be helpful to eliminate or greatly reduce this unwanted chatter.

Since vibration often occurs in localized portions of the machine/workholding/part/tool structure attempts to fix the wrong component will have little or no effect. Damping the tool when the partpiece is vibrating will not improve the cutting and vice versa. Many designs have been developed to dampen tools and machine structures but these are not effective when vibration originates in the rotating part or its workholding. In this example the workpiece is supported from one end as a cantilever beam. Deflection increases with the 3^{rd} power of beam length rapidly reducing stiffness for taller parts. Thin part walls and openings can weaken the part. Clamps and supports often cannot be located at the point where the tool is cutting. This loss of stiffness is further reduced by low damping ratios of 1-2% found in typical metal components. Dynamic stiffness is the product of static stiffness and damping when resonance occurs.

Vertical turning machines can include a rotating table assembly having a mass damper assembly that reduces or eliminates unwanted chatter or periodic surface imperfections on a surface of a workpiece. The mass damper assembly can consist of a mass connected to a support through a system of spring-damper elements. The mass may be made from one or more components rigidly attached together. Locating features, in this example circular grooves, engage the elastomer rings to support the mass and transfer vibration forces to the mass. The location of the pattern center of spring-damper elements is coincident vertically and horizontally with the mass center of gravity. This location causes the mass to move translationally without tilting and results in the greatest reaction force. In this example where cutting is done to the upper half of the workpiece outside and workpiece inside the damper was designed as a ring located midway down on the outside of the workpiece holder. The same principles can be used to configure the damper as a smaller ring or plug that could attach to the top or inside of the part piece. The mass damper assembly can include an upper mass rigidly coupled to a lower mass such that the upper mass supports the mass damper assembly on at least one elastomeric spacer supported by an elastomeric spacer assembly rigidly coupled to the rotating table assembly. The mass damper assembly can be positioned radially outwardly with respect to a fixture holding a workpiece so that the workpiece is concentrically received within the mass damper assembly. As elongated workpieces are held by the workpiece holder of the rotating table assembly, the mass damper assembly can dissipate the cutting vibration energy before it grows to an excessive level thereby creating a more stable workpiece for machining.

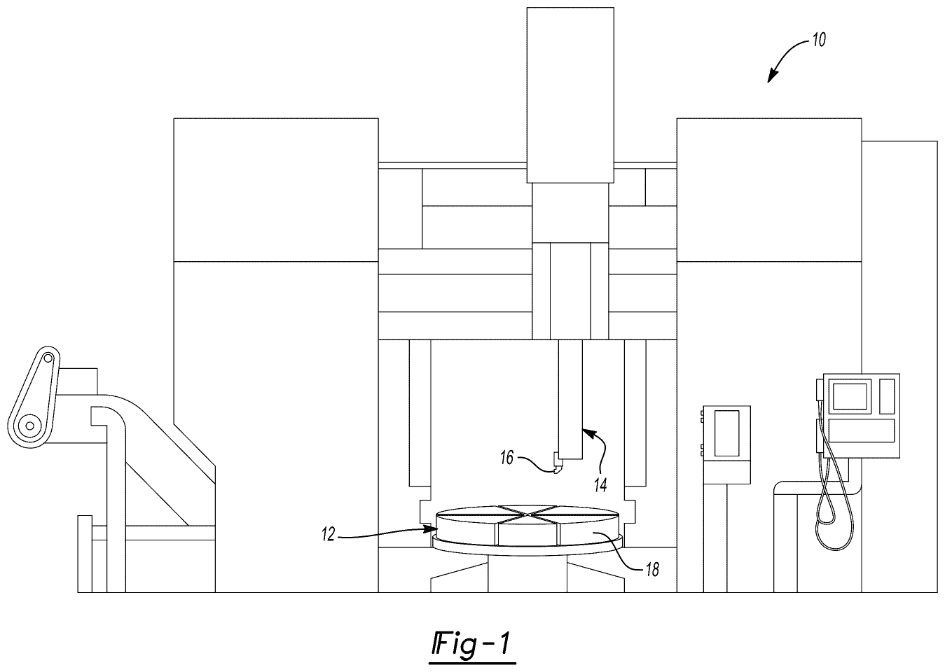

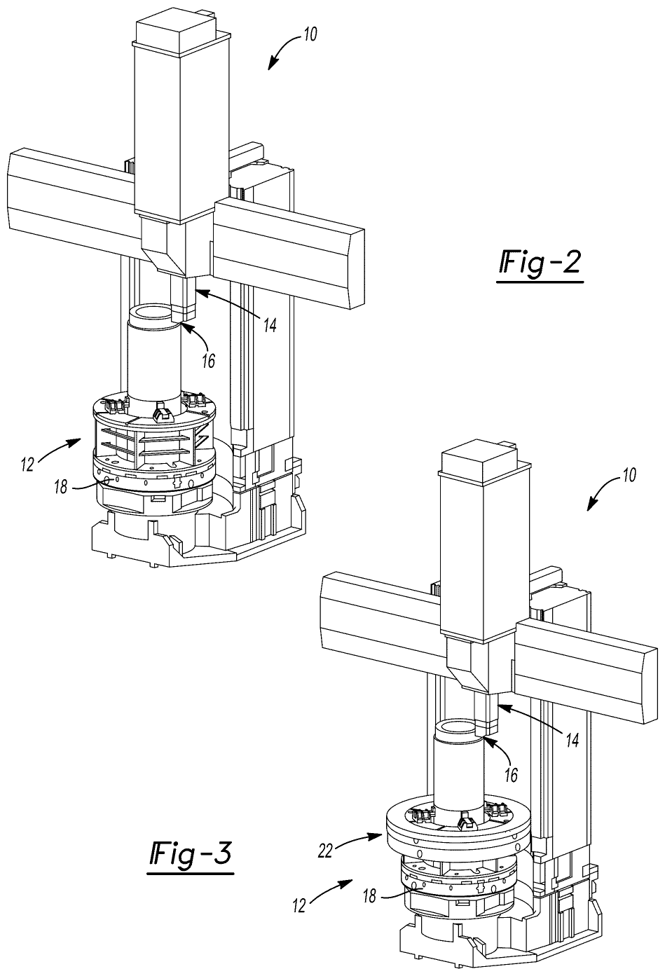

FIG. 1 depicts an embodiment of a vertical turning center (VTC) 10, which may also be referred to as a vertical lathe. The VTC 10 can include a rotating table assembly 12 capable of releasably holding and spinning a workpiece as well as a ram 14 having a cutting tool 16 at a distal end that engages an outer surface of the workpiece to selectively remove material from the workpiece. The outer surface of the workpiece can include a surface at an inner diameter, an outer diameter, or an end of a workpiece. The rotating table assembly 12 can include a table base 18, a fixture 20 for releasably holding a workpiece, and a mass damper assembly 22, shown in more detail in FIGS. 2-4. A rotating electrical machine (not shown) can have an output shaft coupled to the rotating table assembly 12 and may spin the table base 18 along with a workpiece and mass damper assembly 22 about a vertical (Z) axis at a desired angular velocity in response to electrical current supplied to the machine. The mass damper assembly 22 will be discussed in more detail below. The workpiece can be releasably secured to the rotating table assembly 12 via the fixture 20. A variety of different fixture designs can be used, for example the fixture could be implemented using a collet or a chuck. As the workpiece rotates along with the rotating table assembly 12, the ram 14 can move the cutting tool 16 so that the cutting tool 16 engages with an outer surface of the workpiece to perform cutting operations. The ram 14 can extend in the X direction or the Z direction to move the cutting tool 16 along the axial length of an elongated workpiece to cut at different axial positions along the workpiece and/or to change the diameter/radius of the surface being cut. Implementations of the VTC include a Fives Giddings and Lewis VTC 1600 vertical turning center and a Fives Giddings and Lewis VTC 2000 vertical turning center but other vertical or horizontal turning centers could include the described mass damper assembly.

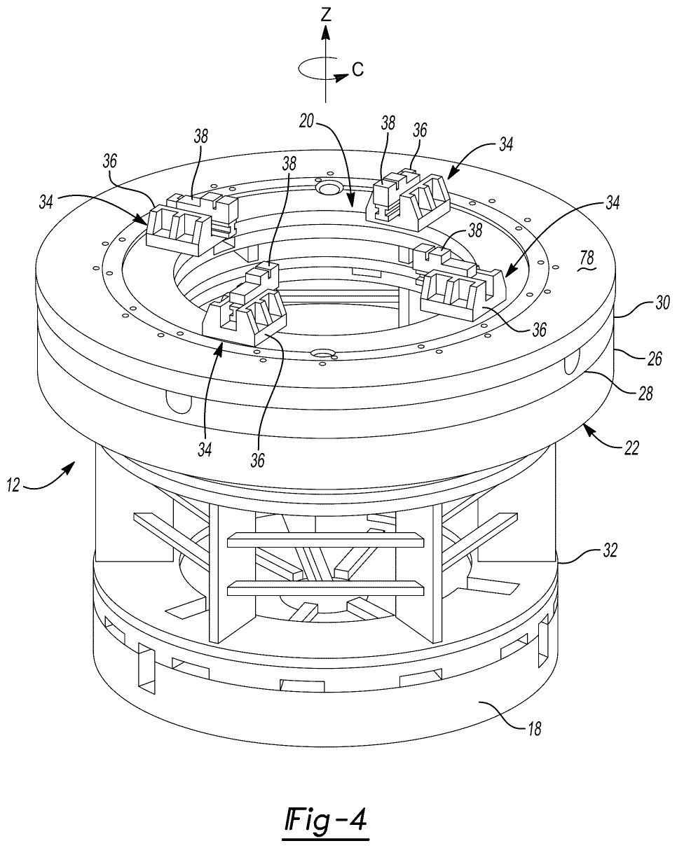

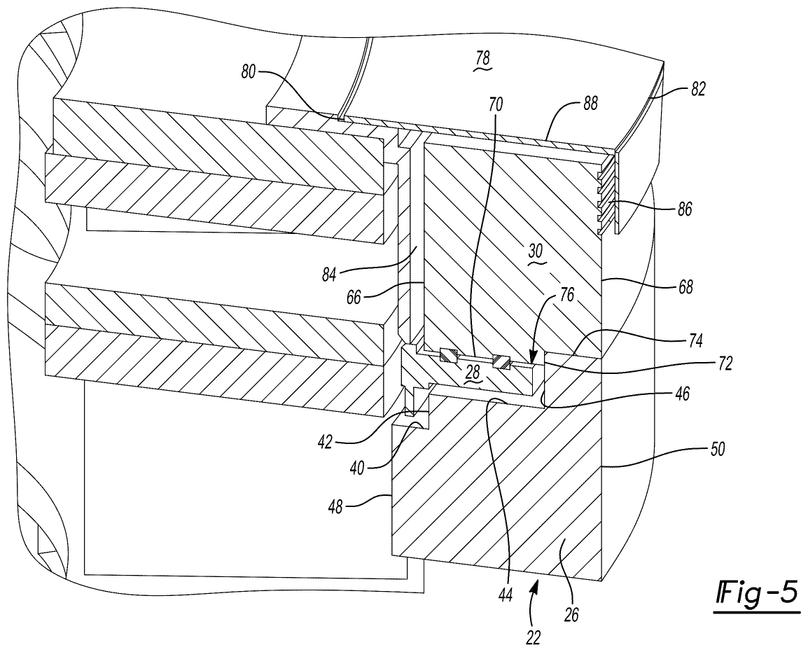

FIGS. 3 and 4 depict an implementation of the mass damper assembly 22 used with the rotating table assembly 12 of the VTC 10. The mass damper assembly 22 is rotatably carried by the rotating table assembly 12 and includes a lower mass 26, an upper mass 30 fastened to the lower mass 26, and an elastomeric spacer assembly 28 engaging a radially extending surface of the upper mass 30, such that the elastomeric spacer assembly 28 can be rigidly coupled to the rotating table assembly 12, support the lower mass 26/upper mass 30, and the radially-extending surface of the upper mass 30 compresses elastomeric spacers included in the elastomeric spacer assembly 28.

The fixture 20 can be coupled to the table base 18 to prevent angular displacement of the fixture 20 relative to the table base 18. The fixture 20 can include a fixture base 32 and a workpiece holder 34 that rests on and is coupled to the fixture base 32. The fixture base 32 can raise the workpiece holder 34 above the table base 18 in the Z direction and have an inner diameter so as to receive the workpiece concentrically within the fixture base 32 such that an end of the workpiece can rest on the table base 18. The workpiece holder 34 can include a plurality of chucks 36 spaced apart around an inner diameter of the fixture base 32 and having linearly actuated workpiece-engaging-jaws 38 that move toward an axis of workpiece rotation (C), engaging an outer surface of the workpiece, holding the workpiece to prevent movement of the workpiece relative to the rotating table assembly 12.

FIG. 5 depicts a portion of an implementation of a mass damper assembly 22 used with the VTC 10. The lower mass 26 can have a first radial surface 40, a first axial surface 42, a second radial surface 44, and a second axial surface 46. The lower mass 26 can directly couple to the upper mass 30 via one or more fasteners and have a substantially annular shape with an inner diameter 48 and an outer diameter 50. The lower mass 26 can be formed in a plurality of segments to facilitate assembly and disassembly. Gaps at surfaces 40 and 42 allow motion of the mass but are arranged to prevent coolant and chips from entering between the mass 26 and support frame 52.

In this implementation, a spatial orientation of an upper mass and a lower mass is used. However, it should be appreciated that implementations with other spatial orientations are possible. For instance, the mass damper assembly can include a single mass or three or more masses. It may be possible for the mass damper assembly to include one mass and an elastomeric spacer assembly engaging a radially-extending surface of the mass, such that the elastomeric spacer assembly can be rigidly coupled to the rotating table assembly, support the mass, and the radially-extending surface of the mass compresses elastomeric spacers included in the elastomeric spacer assembly.

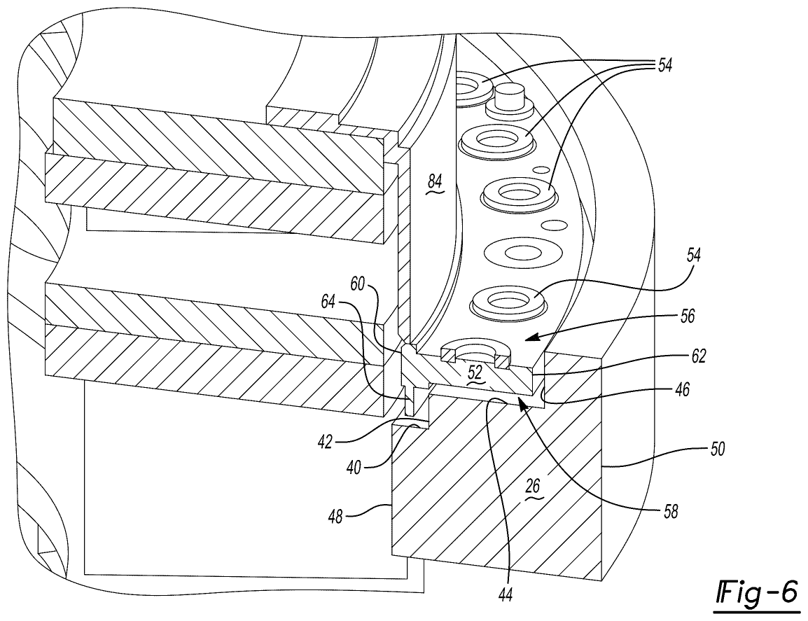

FIG. 6 depicts a portion of an implementation of a mass damper assembly 22 used with the VTC 10. The elastomeric spacer assembly 28 can include a spacer frame 52 holding a plurality of elastomeric spacers 54 that are exposed on a first spacer side 56 opposite a second spacer side 58. The spacer frame 52 can have an annular shape extending from an inner diameter 60 to an outer diameter 62. The first spacer side 56 is positioned in between the inner diameter 60 and outer diameter 62; the second spacer side 58 is also positioned between the inner diameter 60 and the outer diameter 62 facing in an opposite direction of the first spacer side 56. The spacer frame 52 can include an inner ring 64 that extends in an axial direction (Z) away from the spacer frame 52.

The elastomeric spacers 54 can be positioned around the spacer frame 52 in between the inner diameter 60 and outer diameter 62 along the first spacer side 58 so that the elastomeric spacers 54 face upwards toward the upper mass 30. In this implementation, a plurality of elastomeric spacers is used and each elastomeric spacer is substantially ring-shaped. The elastomeric spacers 54 can be positioned on one side of the spacer frame 52 such that the spacers 54 engage the lower mass 26 or the upper mass 30. However, it should be appreciated that other implementations of an elastomeric spacer or spacers are possible. For instance, the elastomeric spacers can be shaped differently and/or be implemented so as to include one or multiple elastomeric spacers that encircles the outer diameter 62 of the spacer frame 52. It may be possible to include one or more elastomeric spacers on both the first spacer side and the second spacer side in other implementations. The damping elements are arranged so that fixture vibrations are absorbed as they are transmitted through support frame 52 into damper masses 26 and 30. A large number of spacer pockets (in this example 48) are provided even though only 16 are used here to provide the capability to adjust system performance by varying the number of elastomeric spacers. The elastomeric spacers can be shaped, sized, and formed from a material each chosen for the damping and/or spring rate desired depending on the mass amounts included in the upper and lower masses. The elastomeric spacers 54 can be formed from a wide array of different materials that provide cushioning but can return to its original shape when a load is removed from the material. Examples include natural rubber, neoprene, PVC, EPDM, and ethylene propylene rubber to name a few possibilities.

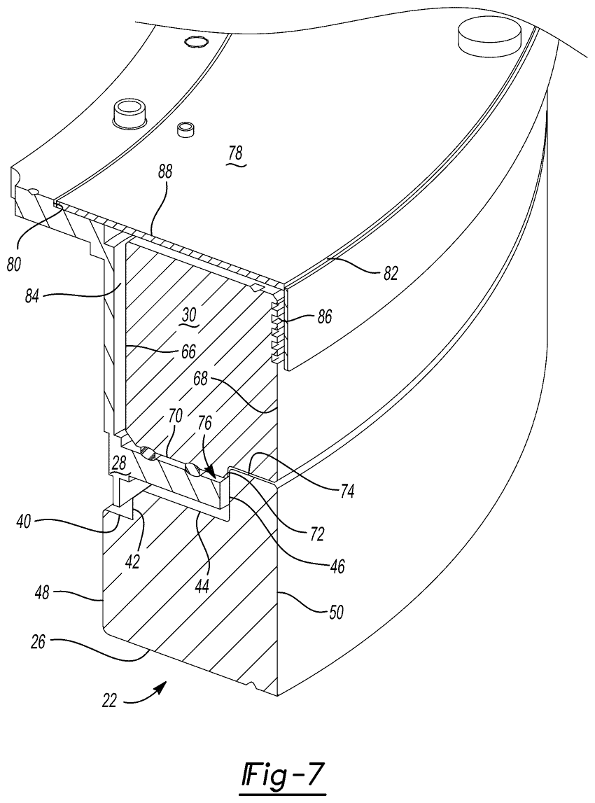

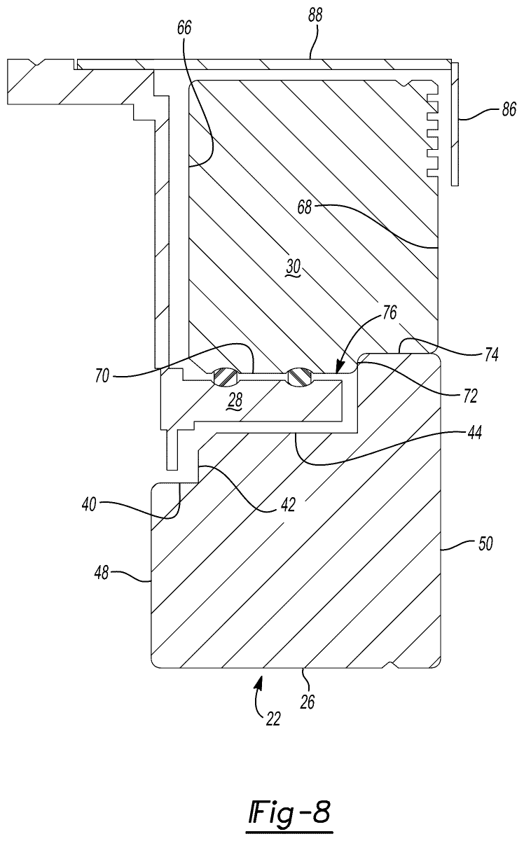

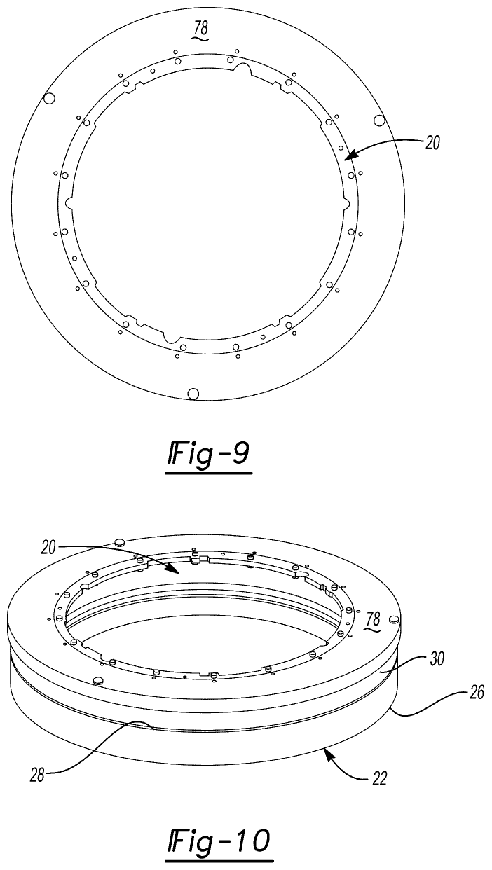

FIGS. 7-10 depict portions of an implementation of a mass damper assembly 22 used with the VTC 10. The upper mass 30 can have an annular shape with an inner diameter 66 and an outer diameter 68; in between, the upper mass 30 can have a first radial surface 70, a first axial surface 72, and a second radial surface 74 on a lower side 76 of the upper mass 30. The upper mass 30 can rest on the elastomeric spacers 54 via the first radial surface 70. Given that the upper mass 30 is rigidly coupled to the lower mass 26, both the lower mass 26 and the upper mass 30 are supported on the elastomeric spacers 54 via the first radial surface 70. It can be helpful to have the elastomeric spacers 54 positioned in plane with the lower mass 26 and upper mass 30.

A cover 78 can couple to the spacer frame 52 to at least partially enclose a portion of the upper mass 30. The cover 78 may not contact the upper mass 30, but can help prevent cut materials from fouling the mass damper assembly 22. The cover 78 can include an inner diameter 80, an outer diameter 82, and a wall 88 extending between the inner diameter 80 and the outer diameter 82. The cover 78 can include an outer axial surface 86. The outer axial surface 86 can be positioned radially-outwardly from the outer diameter 68 of the upper mass 30. The spacer frame 52 can be coupled to the fixture 20 using a plurality of fasteners, such as threaded bolts, that engage the fixture 20 and hold the damper assembly relative to the fixture 20.

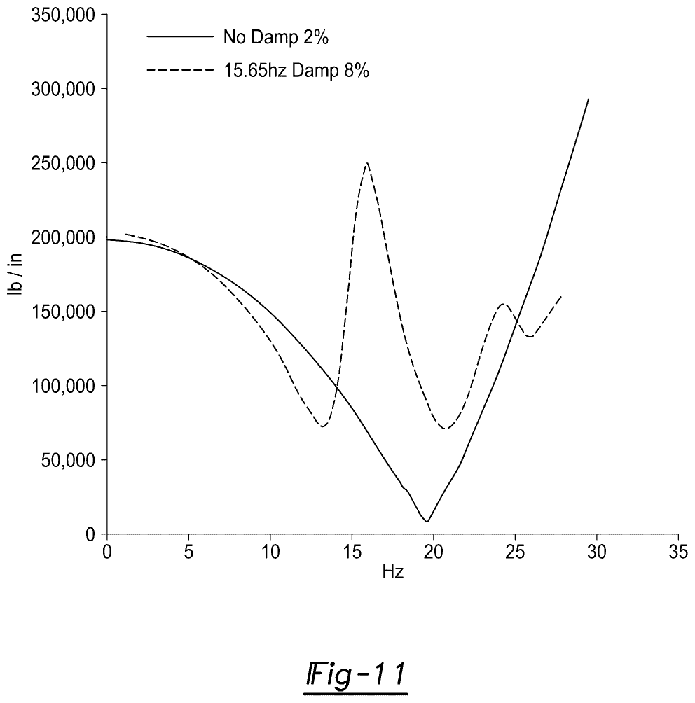

FIG. 11 is a graph depicting a comparison of dynamic stiffness of a workpiece at different frequencies using a VTC having a rotating table without a mass damper assembly and using VTC having a rotating table assembly including a mass damper assembly. In the VTC using a rotating table without a mass damper assembly (curve “no damp 2%”) we see that dynamic stiffness of the workpiece as it is held by the fixture has very low dynamic stiffness at approximately 19 Hz, whereas the level of dynamic stiffness provided by a workpiece held by a fixture and a rotating table assembly with a mass damper assembly is much greater (curve “15.65 hz 8%”).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A vertical turning center for cutting workpieces, comprising:
a rotating table assembly that is configured to releasably couple to a workpiece and spin the workpiece at a speed sufficient to cut the workpiece;
a ram having a cutting tool at a distal end configured to engage an outer surface of the workpiece; and
a mass damper assembly coupled to the rotating table assembly and supported by at least one elastomeric spacer.

2. The vertical turning center recited in claim 1, wherein the rotating table assembly further comprises a fixture that is configured to releasably hold the workpiece.

3. The vertical turning center recited in claim 1, wherein the mass damper assembly comprises an upper mass coupled to a lower mass via at least one fastener.

4. The vertical turning center recited in claim 1, wherein the mass damper assembly is positioned radially outwardly with respect to the fixture holding the workpiece so that the workpiece is concentrically received within the mass damper assembly.

5. The vertical turning center recited in claim 1, wherein the upper mass rests on the elastomeric spacers via a first radial surface.

6. A vertical turning center for cutting workpieces, comprising:
a rotating table assembly that is configured to releasably couple to a workpiece and spin the workpiece at a speed sufficient to cut the workpiece;
a ram having a cutting tool at a distal end configured to engage an outer surface of a workpiece;
a mass damper assembly, having an upper mass coupled to a lower mass; and
an elastomeric spacer assembly, coupled to the rotating table assembly, having one or more elastomeric spacers engaging a radially-extending surface of the upper mass.

7. The vertical turning center recited in claim 6, wherein the rotating table assembly further comprises a fixture that is configured to releasably hold the workpiece.

8. The vertical turning center recited in claim 6, wherein the mass damper assembly comprises an upper mass coupled to a lower mass via at least one fastener.

9. The vertical turning center recited in claim 6, wherein the mass damper assembly is positioned radially outwardly with respect to the fixture holding the workpiece so that the workpiece is concentrically received within the mass damper assembly.

10. The vertical turning center recited in claim 6, wherein the upper mass supports the mass damper assembly on at least one elastomeric spacer supported by an elastomeric spacer assembly coupled to the rotating table assembly.

11. The vertical turning center recited in claim 6, wherein the radially-extending surface of the upper mass compresses one or more elastomeric spacers included in the elastomeric spacer assembly.

12. The vertical turning center recited in claim 6, wherein the upper mass can rest on the elastomeric spacers via a first radial surface.
